(19) United States
(12) Patent Application Publication
(10) Pub. No.: US 2004/0122143 A1
(43) Pub. Date: Jun. 24, 2004

(54) Hot-melt adhesive based on a copolymer of ethylene and of an alkyl (meth) acrylate

(76) Inventors: Eric Radigon, Bernay (FR); Jean Lebez, Evreux (FR); Jean-Michel Pierrot, Grosley sur Risle (FR)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/703,501

(22) Filed: Nov. 10, 2003

Related U.S. Application Data
(63) Continuation of application No. 09/341,543, filed on Feb. 17, 2000, now abandoned.

(30) Foreign Application Priority Data
Nov. 14, 1997 (FR) 97/14320

(51) Int. Cl. C08L 1/00

(52) U.S. Cl. 524/272

(57) ABSTRACT

A hot-melt adhesive based on a copolymer of ethylene and of an alkyl (meth)acrylate.

The present invention relates to a hot-melt adhesive based on a copolymer of ethylene and of an alkyl (meth)acrylate.

Hot-melt adhesives are thermoplastic materials which are solid at room temperature and which, on heating, become viscous liquids. These viscous liquids are applied to a first substrate and then the substrate is covered with a second surface. On cooling, adhesion is obtained between the substrate and the second surface. The assembly time is the period during which the adhesive which has been applied to a substrate, which is at room temperature, remains tacky, that is to say the interval of time during which it is possible to apply the second surface and, on cooling, to obtain adhesion between the substrate and the second surface.

Once this assembly time period has been exceeded, it is no longer possible to obtain sufficient adhesion between the substrate and the second surface.

These adhesives are denoted by the abbreviation HMA (hot-melt adhesives). Adhesives having an infinite assembly time are necessary for self-adhesive labels or adhesive tapes which are used at room temperature. Depending on the nature of the adhesive, it is possible to obtain more or less strong adhesions, for example to detach and reattach the label. Bonding is achieved by pressure at room temperature. The adhesive is deposited on the substrate (for example, label or tape) while hot. These adhesives are denoted by HMPSA (hot-melt pressure-sensitive adhesives). They are also sometimes denoted as self-adhesive hot-melt compositions. The present invention relates to these two types of hot-melt adhesives, that is to say HMAs and HMPSAs.

According to the prior art, see, for example, Ullmann's Encyclopedia of Industrial Chemistry, 5th edition (1995), Vol. A 26, p. 659-660, HMPSAs are preferably based on SIS (styrene/isoprene/styrene) but also SBS (styrene/butadiene/styrene) block copolymers.

Mention has been made, in U.S. Pat. No. 5,373,041, relating to HMPSAs, as disadvantages of SBSs and SISs, of their instability towards heat and towards U.V. radiation, as well as of their-poor resistance to oils. Provision was thus made, in this patent, to replace SBSs and SISs with copolymers composed of 60 to 70% (by weight) of ethylene, 30 to 40% of n-butyl acrylate and from 0 to 5% of (meth)acrylic acid, which can be neutralized by metal ions.

Application WO 97/12007 discloses HMPSAs based on an ethylene/alkyl acrylate copolymer. The examples only relate to butyl acrylate.

It has now been discovered that ethylene/alkyl meth(acrylate) copolymers, the alkyl group having at least 5 carbon atoms and advantageously 6 to 24 carbon atoms, make it possible to prepare HMPSA adhesives with properties essentially similar to those based on SIS or SBS, while having a better loop tack, a better finger tack and a better level of peeling than ethylene/butyl acrylate copolymers.

As regards adhesives of HMA type, heavy (meth)acrylates of 2-ethylhexyl acrylate type contribute better low-temperature behaviour in comparison with butyl or ethyl acrylate. Furthermore, they can be applied at low temperature (cool melt), for example between 130 and 150° C.

The present invention is thus a hot-melt adhesive comprising:

an ethylene/alkyl (meth)acrylate copolymer (A), the alkyl group having at least 5 carbon atoms,

a tackifying resin, optionally a plasticizer and optionally a wax.

The adhesives of the HMPSA type are deposited while hot (molten) on a substrate, such as, for example, a tape made of paper or of polyamide or a polyolefin or polyester substrate; on cooling, a face is obtained which is adhesive at room temperature. This adhesive face can be protected before use by a silicone-containing paper or the other face of the substrate (rolling up of an adhesive tape on itself).

In the continuation of the text, reference is made to various measurement tests or methods which make it possible to determine the properties of HMPSAs and HMAs:

FTM9: The loop tack test is the FINAT FTM 9 test described in the FINAT technical manual, Laan Copes Van Cattenbubch 79, NL 2585 EW, THE HAGUE (1995) (HMPSA).

This test characterizes the instantaneous adhesion or “tack”. The tack is defined as being the force required to detach an HMPSA-coated PET (polyethylene terephthalate) loop, a predetermined surface of which has been brought into contact beforehand with a stainless steel plate.

The HMPSA is coated, between 140° C. and 180° C., on a 25×400 mm² PET strip. The thickness being constant, the weight per unit area is between 18 g/m² and 22 g/m². The test strips must be conditioned for at least four hours before the test in a controlled-environment room at 23±2° C. and 50±5% RH (relative humidity). The self-adhesive tape is applied using a standardized 2 kg conventional roller.

The test is carried out using a dynamometer, at a traction rate of 300 mm/min, in a controlled-environment room at 23±2° C. and 50+5% RH.

The loop tack is quantified by the value of the maximum force. The result of the loop-tack measurement test is given in N/cm. The type of failure must also be mentioned.

The various types of failure are defined as follows:

Adhesive Failure

The HMPSA does not adhere to one of the two substrates.

Cohesive Failure

Failure in the adhesive seal is observed. In this case, the two adhesively-bonded substrates carry away part of the seal during traction.

Mixed Failure

Failure is indecisive and both types of failures described above can be observed on the same test specimen.

FTM8: The creep behaviour is determined by the FTM8 test (FINAT manual already mentioned) (HMPSA).

The creep test measures the ability of an HMPSA to withstand a static force of 1 kgf at a given temperature (at ambient temperature in the examples of the present invention).

The resistance to static shearing is defined by the time necessary to separate, by parallel vertical slippage, an area of 25×25 mm², coated with HMPSA, from a flat stainless steel plate.

The HMPSA is coated, between 140° C. and 180° C., on a 25×400 mm² PET strip. The thickness being constant, the weight per unit area is between 18 g/m² and 22 g/m². The test strips must be conditioned for at least four hours before the test in a controlled-environment room at 23±2° C. and 50±5% RH. The self-adhesive tape is applied using a standardized 2 kg conventional roller.

The result of the creep test is given in minutes. The type of failure must also be mentioned.

FTM1: Adhesion to steel is determined by the FTM1 test (FINAT manual already mentioned) (HMPSA).

This test quantifies the adhesiveness. The latter is defined as being the force required to remove a PET strip, coated with HMPSA, from a stainless steel plate.

The HMPSA is coated, between 140° C. and 180° C., on a 25×400 mm PET strip. The thickness being constant, the weight per unit area is between 18 g/m² and 22 g/m². The test strips must be conditioned for at least four hours before the test in a controlled-environment room at 23 ±2° C. and 50±5% RH. The self-adhesive tape is applied using a standardized 2 kg conventional roller.

The adhesive force is measured 20 minutes after application. The test is carried out using a dynamometer, at a peel angle of 180°, at a rate of 300 mm/min in a controlled-environment room at 23±2° C. and 50±5% RH.

The result of the peel test is given in N/cm. The type of failure must be mentioned.

Cloud Point (HMA and HMPSA):

The cloud point is determined as follows: the adhesive is heated to 175° C., then a drop is deposited on the bulb of an ASTM thermometer, and then the temperature at which cloudiness appears during cooling is recorded. A value of less than 50° C. or 60° C. indicates good compatibility between the constituents of the hot melt.

Brookfield Viscosity (HMA and HMPSA):

Measured at 170° C., needle 27 at 10 revolutions/minute according to ASTM D 3236.

SAFT (Shear Adhesion Failure Temperature) (HMA and HMPSA)

The SAFT test (ASTM D 4498) measures the ability of a hot-melt adhesive to withstand a static force of 0.5 kg (or 0.25 kg) under the effect of a steady rise in temperature of 0.4° C./min.

The SAFT is defined by the temperature at which separation, by parallel vertical slippage, may be observed of an area of 25×25 mm², coated with HMPSA, from a flat stainless steel plate.

The hot-melt adhesive is coated, between 140° C. and 180° C., on a 25×400 mm² PET strip. The thickness being constant, the weight per unit area is between 18 g/m² and 22 g/m². The test strips must be conditioned for at least four hours before the test in a controlled-environment room at 23±2° C. and 50±5% RH. The self-adhesive tape is applied using a standardized 2 kg conventional roller.

The result of the SAFT is given in ° C. The type of failure must be mentioned.

Finger Tack (Internal Method) (HMPSA)

This test gives an idea of the immediate adhesion of an HMPSA coated onto a PET substrate. The finger tack value is between 0 and 3.

0: no tack,

1: insufficient tack,

2: good tack,

3: excellent tack.

Rolling Ball Tack Test ASTM D 3121 of 1989 (HMPSA)

During the determination of the tack of an adhesive according to the rolling ball tack method, a steel ball is released at the top of an inclined plane.

The ball accelerates and rolls along a horizontal surface covered with the test product. The tack is determined by measuring the distance travelled by the ball before it comes to a halt.

Equipment

Device equipped with an inclined plane of 20.0±0.20°

Steel ball with a mass of 5.60±0.05 g

Polyethylene terephthalate (PET) strips coated with test products.

The ethylene/alkyl (meth)acrylate copolymer (A) is such that the alkyl group contains at least 5 carbon atoms.

This is because the Applicant Company has discovered that alkyls having at least 5 carbon atoms give tack to the HMPSAs and good low-temperature properties to the HMAs.

The alkyl can be linear, branched or cyclic. It advantageously comprises 6 to 24 carbon atoms. Mention may be made, as example of these alkyl (meth)acrylates, of 2-ethylhexyl (meth)acrylate and octyl acrylate.

The (meth)acrylate content is advantageously at most 50% and preferably between 20 and 40% by weight. The melt flow index (or MFI) can be between 0.1 and 1000 and is preferably at least 200 (in g/10 min according to ASTM D 1238-73, conditions E, at 190° C. under a load of 2.16 kg).

It would not be departing from the scope of the invention to use a mixture of at least two ethylene/alkyl (meth)acrylate copolymers.

According to another form of the invention, (A) can be a mixture of two copolymers (A₁) and (A₂) with different MFI values.

Advantageously, (A₁) has an MFI of less than 10 and (A₂) has an MFI of greater than 10. For example, the MFI of (A₁) is between 1 and 3 and the MFI of (A₂) is between 50 and 400.

As regards the HMAs, the adhesives of the invention comprise one or more tackifying resins, at least one wax, and optionally fillers and/or stabilizers.

As regards the HMPSAs, the adhesives of the invention comprise one or more tackifying resins, one or more plasticizers and optionally stabilizers.

Tackifying resins which are suitable are, for example, rosin, rosin esters, hydrogenated rosin, polyterpenes and derivatives, aromatic or aliphatic petroleum resins, or hydrogenated cyclic resins. These resins typically have a ring-and-ball softening temperature of between 25° C. and 180° C. and preferably between 50° C. and 135° C.

The amount of tackifying resin can be from 50 to 180 parts per 100 parts of (A) and preferably 100 to 150 parts.

Other examples of rosin derivatives are described in Ullmann's (cited above), Vol. A 23, p. 79-86, the contents being incorporated in the present application.

Mention may be made, as derivatives of rosin, of those obtained by hydrogenation, dehydrogenation, polymerization or esterification. These derivatives can be used as is or in the form of esters of polyols, such as esters of pentaerythritol, polyethylene glycol and glycerol.

Mention may also be made, as tackifying resin, of dicyclopentadienes.

The adhesives of the invention can comprise waxes. The waxes make it possible to adjust the fluidity, the assembly time and the setting time.

The waxes can be recovered during the refining of oil fractions. They are, for example, waxes composed essentially of paraffinic hydrocarbons and comprising sufficient amounts of branched, cyclic and aromatic hydrocarbons to be much less crystalline than paraffin waxes. It is also possible to use synthetic waxes, such as Fischer-Tropsch waxes.

The paraffin waxes used in the adhesives of the invention advantageously have a melting temperature of greater than 50° C. and preferably between 60° C. and 70° C.

The amount of wax can be between 30 and 80 parts per 100 parts of copolymer. (A).

The plasticizers which can be used in the adhesives of the invention are, for example, paraffinic, aromatic or naphthenic mineral oils. They serve essentially to lower the viscosity and to introduce tack. The amount of plasticizer can be between 10 and 30 parts per 100 parts of (A).

Mention may also be made, as plasticizer, of phthalates, azelates, adipates, tricresyl phosphate and polyesters.

As regards the HMAs, the adhesives of the invention can comprise fillers. Mention may be made, as examples of fillers, of silica, alumina, glass, glass beads, calcium carbonates, fibres and metal hydroxides. These fillers must not reduce either the tack or the mechanical properties of the adhesive after it has been applied. The amount of fillers can represent up to 100 parts per 100 parts of (A).

It is recommended to add stabilizers, such as antioxidants; the usual antioxidants for thermoplastics can be used.

The hot-melt adhesives of the invention are prepared by mixing in the molten state, at temperatures between 130° C. and 200° C., until a homogeneous mixture is obtained. The duration of mixing can be of the order of 30 minutes to 3 hours. The usual devices for thermoplastics, such as extruders, rollers, Banbury or Brabender mixers, or propeller mixers, can be used.

### EXAMPLES

The following products were used:

SIS: styrene/isoprene/styrene block copolymer containing 15% by weight of polystyrene, sold by Shell Chimie under the reference Kraton-D-1161 N.

E/2-EHA/3 to 8: ethylene/2-ethylhexyl acrylate (2-EHA) copolymers with characteristics:

| | 2-EHA | | M.p. (° C.) | Tg (° C.) |
|---|---|---|---|---|
| | (weight | MFI | measured | measured |
| | %) | (g/10 min) | by D.S.C. | by D.S.C. |
| E/2-EHA/3 | 26 | 3 | 89 | −36 |
| E/2-EHA/5 | 25 | 45 | 88 | −28 |
| E/2-EHA/7 | 27 | 120 | 85 | −39 |
| E/2-EHA/8 | 37 | 410 | 73 | −42 |

Permalyn 5095: solid rosin glycerol ester (produced by Hercules)

Catenex N 956: aliphatic paraffinic oil (produced by Shell)

Irganox 1010: phenolic antioxidant (produced by Ciba Speciality Chemicals).

The properties of the HMPSAs produced with SIS (not in accordance with the invention) and according to the invention with E/2-EHA copolymers are shown in the following tables. The composition of the HMPSA is stated at the head of each table.

For example, the E/2-EHA/7 column means that this is an HMPSA based on the E/2-EHA/7 copolymer.

35 BA 40 denotes an ethylene/butyl acrylate copolymer comprising 35% by weight of acrylate and of MFI: 40 (in g/10 min at 190° C. under a load of 2.16 kg according to ASTM D 1238), Tg 67° C.

28 BA 175 denotes an ethylene/butyl acrylate copolymer comprising 28% by weight of acrylate and of MFI: 175 (in g/10 min at 190° C. under a load of 2.16 kg according to ASTM D 1238), Tg 80° C.

30 BA 02 denotes an ethylene/butyl acrylate copolymer comprising 30% by weight of acrylate and of MFI: 2 (in g/10 min at 190° C. under a load of 2.16 kg according to ASTM D 1238), Tg 78° C.

35 BA 320 denotes an ethylene/butyl acrylate copolymer comprising 35% by weight of acrylate and of MFI: 320 (in g/10 min at 190° C. under a load of 2.16 kg according to ASTM D 1238), Tg 66° C.

TABLE 1
35% (Copolymer (A) or SIS), 40% Permalyn 5095,
25% Catenex N956 and 0.2% Irganox 1010

| | | | E/2- | 35 BA | E/2- | 28 BA |
|---|---|---|---|---|---|---|
| TESTS | UNITS | SIS | EHA/5 | 40 | EHA/7 | 175 |
| Cloud point | ° C. | <50 | <50 | <50 | <50 | <50 |
| Brookfield | mPa · s | 9350 | 8830 | 4550 | 3800 | 1800 |
| viscosity | | | | | | |
| 170° C. | | | | | | |
| 10 r/min, | | | | | | |
| Nee. 27 | | | | | | |
| S.A.F.T. | ° C. | | | | | |
| PET/PET | | | | | | |
| 500 g | | <30 | <30 | <30 | <30 | <30 |
| 250 g | | 54.9 | 53.9 | 60.7 | 58.5 | 64.9 |
| s | | 0.7 | 1.4 | 0.5 | 2.0 | 1.0 |
| ASTM D 4498 | | | | | | |
| Static creep | min | | | | | |
| PET/STAIN- | | | | | | |
| LESS STEEL | | | | | | |
| 1000 g, 23° C. | | 42 | 0 | 3 | 17 | 55 |
| s | | 9 | 0 | 1 | 8 | 20 |
| Type of | | CF | (AF, | (AF, | CF | CF |
| failure | | | Stain- | Stain- | | |
| FTM8 | | | less | less | | |
| | | | steel) | steel) | | |
| Peel at 180° | N/cm | | | | | |
| PET/Stain- | | 4.5 | 2.5 | 1.2 | 3.3 | 2.8 |
| less steel/ | | | | | | |
| 23° C. | | | | | | |
| s | | 0.5 | 0.2 | 0.5 | 0.6 | 0.4 |
| Type of | | CF | (AF, | (AF, | CF | CF |
| failure | | | Stain- | Stain- | | |
| FTM1 | | | less | less | | |
| | | | steel) | steel) | | |

AF: Adhesive failure;
CF: Cohesive failure;
MF: Adhesive mixed failure;
(AF): Adhesive failure with slight deposition of material on the plate

TABLE 2
35% (Copolyrner (A) or SIS), 40% Permalyn 5095,
25% Catenex N956 and 0.2% Irganox 1010

| | | | E/2- | 35 BA | E/2- | 28 BA |
|---|---|---|---|---|---|---|
| TESTS | UNITS | SIS | EHA/5 | 40 | EHA/7 | 175 |
| Rolling ball | cm | | | | | |
| tack on PET | | | | | | |
| s | | 3 | 17 | 5 | 10 | 9 |
| PSTC 6 | | 0 | 3 | 0 | 1 | 1 |
| Finger tack* | — | 3 | 1.5 | 1.5 | 2 | 1.5 |
| Loop tack | N/cm | | | | | |
| PET/Stainless | | 3.7 | 3.3 | 2.4 | 4.8 | 3 |
| steel/23° C. | | | | | | |
| s | | 0.7 | 0.7 | 0.1 | 0.7 | 1.0 |
| Type of failure | | (AF, | (AF, | (AF, | CF | (AF, |
| FTM9 | | Stain- | Stain- | Stain- | | Stain- |
| | | less | less | less | | less |
| | | steel) | steel) | steel) | | steel) |

AF: Adhesive failure;
CF: Cohesive failure;
MF: Adhesive mixed failure;
(AF): Adhesive failure with slight deposition of material on the plate
*3: Strong tack; 2: Moderate tack; 1: Week tack; 0: No tack

TABLE 3
30% (Copolymer (A) or SIS), 40% Permalyn 5095,
30% Catenex N956 and 0.2% Irganox 1010

| TESTS | UNITS | SIS | E-2EHA/3 | 30 BA 02 |
|---|---|---|---|---|
| Cloud point | ° C. | <50 | <50 | <50 |
| Brookfield | mPa · s | 4850 | 11,900 | 11,800 |
| Viscosity | | | | |
| 170° C. | | | | |
| 10 r/min, Nee 27 | | | | |
| S.A.F.T. | ° C. | | | |
| 250 g | | 49.0 | 51.1 | 51.6 |
| s | | 2.0 | 4.2 | 4.0 |
| ASTM D 4498 | | | | |
| Peel at 180° C. | N/cm | | | |
| Mylar/Stainless | | 6.1 | 1.1 | 0.1 |
| steel/23° C. | | | | |
| s | | 0.1 | 0.2 | 0.1 |
| Type of failure | | CF | (AF, | (AF, Stain- |
| FTM1 | | | Stainless | less steel) |
| | | | steel) | |

AF: Adhesive failure;
CF: Cohesive failure;
MF: Adhesive mixed failure;
(AF): Adhesive failure with slight deposition of material on the plate

TABLE 4
30% (Copolymer (A) or SIS), 40% Permalyn 5095,
30% Catenex N956 and 0.2% Irganox 1010

| TESTS | UNITS | SIS | E/2-EHA/3 | 30 BA 02 |
|---|---|---|---|---|
| Rolling ball | cm | 3 | 6 | 10 |
| tack on PET | | | | |
| s | | 0 | 1 | 0 |
| PSTC 6 | | | | |
| Finger tack* | — | 3 | 1.5 | 1 |
| Loop tack | | | | |
| PET/Stainless | N/cm | 4.6 | 2.3 | 0.6 |
| steel/23° C. | | | | |
| s | | 0.3 | 0.8 | 0.2 |
| Type of | | (AF, | (AF, | (AF, |
| failure | | Stain- | Stain- | Stain- |
| FTM9 | | less | less | less |
| | | steel) | steel) | steel) |

AF: Adhesive failure;
CF: Cohesive failure;
MF: Adhesive mixed failure;
(AF): Adhesive failure with slight deposition of material on the plate
*3: Strong tack; 2: Moderate tack; 1: Weak tack; 0: No tack

TABLE 5
(15% Copolymer (A₁) + 15% Copolymer (A₂) or 30% SIS),
40% Permalyn 5095, 30% Catenex N956 and 0.2% Irganox 1010

| | | | E/2-EHA/3 + | 30 BA 02 + | E/2-EHA/3 + | 30 BA 02 + | E/2-EHA/3 + | 30 BA 02 + |
|---|---|---|---|---|---|---|---|---|
| TESTS | UNITS | 30% SIS | E/2-EHA/5 | 35 BA 40 | E/2-EHA/7 | 28 BA 175 | E/2-EHA/8 | 35 BA 320 |
| Cloud point | ° C. | <50 | <50 | <50 | <50 | <50 | <50 | <50 |
| Brookfield | mPa · s | 4100 | 7200 | 6850 | 4830 | 4400 | 4700 | 3930 |
| viscosity | | | | | | | | |
| 170° C. | | | | | | | | |
| 10 r/min, Nee. 27 | | | | | | | | |
| S.A.F.T. | ° C. | | | | | | | |
| 250 g | | 50.0 | 51.7 | 57.4 | 52.7 | 44.5 | 47.2 | 40.3 |
| s | | 0.9 | 1.8 | 2.0 | 1.2 | 1.8 | 1.2 | 1.4 |
| ASTM D 4498 | | | | | | | | |
| Static creep | min | | | | | | | |
| PET/Stainless | | | | | | | | |
| steel/23° C. | | | | | | | | |
| 1000 g, | | 240 | 110 | 150 | 60 | 115 | 31 | 16 |
| s | | 24 | 10 | 15 | 11 | 4 | 6 | 5 |
| Type of failure | | CF | CF | MF | CF | MF | CF | MF |
| FTM8 | | | | | | | | |
| Rolling ball tack | cm | | | | | | | |
| on PET | | | | | | | | |
| s | | 3 | >40 | 25 | >40 | 25 | 8 | 14 |
| PSTC 6 | | 1 | | 3 | 3 | 3 | 2 | 2 |
| Finger tack* | — | 3 | 2 | 1 | 2.5 | 2 | 2.5 | 2 |

AF: Adhesive failure;
CF: Cohesive failure
MF: Adhesive mixed failure
(AF): Adhesive failure with slight deposition of material on the plate

TABLE 6
(15% Copolymer (A₁) + 15% Copolymer (A₂) or 30% SIS),
40% Permalyn 5095, 30% Catenex N956 and 0.2% Irganox 1010

| | | | E/2-EHA/3 + | 30 BA 02 + | E/2-EHA/3 + | 30 BA 02 + | E-2EHA/3 + | 30 BA 02 + |
|---|---|---|---|---|---|---|---|---|
| TESTS | UNITS | 30% SIS | E/2-EHA/5 | 35 BA 40 | E/2-EHA/7 | 28 BA 175 | E-2EHA/8 | 35 BA 320 |
| Peel at 180° C. | N/cm | | | | | | | |
| PET/Stainless | | 7.1 | 6.1 | 3.1 | 5.9 | 5.3 | 3.2 | 2.2 |
| steel/23° C. | | | | | | | | |
| s | | 0.7 | 0.4 | 0.6 | 0.2 | 0.2 | 0.4 | 0.2 |
| FTM1 | | CF | CF | (AF, | CF | (AF, | CF | (AF, |
| | | | | Stainless | | Stainless | | Stainless |
| | | | | steel) | | steel) | | steel) |
| Peel at 180° C. | N/cm | | | | | | | |
| PET/Glass/23° C. | | 5.9 | 4.8 | 2.3 | 4.6 | 2.3 | 2.8 | 3.0 |
| s | | 0.2 | 0.7 | 0.3 | 0.6 | 0.9 | 0.3 | 0.7 |
| FTM1 | | CF | CF | AF, glass | CF | (AF, glass) | CF | (AF, glass) |

AF: Adhesive failure;
CF: Cohesive failure;
MF: Adhesive mixed failure;
(AF): Adhesive failure with slight deposition of material on the plate

TABLE 7
(15% Copolymer (A₁) + 15% Copolymer (A₂) or 30% SIS),
40% Permalyn 5095, 30% Catenex N956 and 0.2% Irganox 1010

| | | | E/2-EHA/3 + | 30 BA 02 + | E/2-EHA/3 + | 30 BA 02 + | E/2-EHA/3 + | 30 BA 02 + |
|---|---|---|---|---|---|---|---|---|
| TESTS | UNITS | 30% SIS | E/2-EHA/5 | 35 BA 50 | E/2-EHA/7 | 28 BA 175 | E/2-EHA/3 | 35 BA 320 |
| Loop Tack | N/cm | | | | | | | |
| PET/stainless | | 3.3 | 8.5 | 6.5 | 6.9 | 7 | 7.4 | 6.3 |
| steel/23° C. | | | | | | | | |
| s | | 0.8 | 0.5 | 0.6 | 2.0 | 1.9 | 1.1 | 1.2 |
| FTM9 | | (AF, | CF | (AF, | MF | (AF, | CF | (AF, |
| | | Stainless | | Stainless | | Stainless | | Stainless |
| | | steel) | | steel) | | steel) | | steel) |
| Loop Tack | N · cm | | | | | | | |
| PET/glass/23° C. | | 3.3 | 11.2 | 3.8 | 6.5 | 6.4 | 6.2 | 6.6 |
| s | | 0.2 | 0.8 | 0.7 | 1.5 | 1.3 | 0.3 | 2.0 |
| FTM9 | | (AF, glass) | CF | (AF, glass) | MF | MF | CF | (AF, |
| | | | 1.7 | | 3.2 | 0.7 | | glass) |
| | | | 0.2 | | 0.5 | 0.1 | | |
| | | | (AF, | | (AF, | (AF, | | |
| | | | glass) | | glass) | glass) | | |

AF: Adhesive failure;
CF: Cohesive failure;
MF: Adhesive mixed failure;
(AF): Adhesive failure with slight deposition of material on the plate

1. Hot-melt adhesive comprising:
an ethylene/alkyl (meth)acrylate copolymer (A), the alkyl group having at least 5 carbon atoms,
at least one tackifying resin, optionally a plasticizer and optionally a wax, this adhesive being deposited while hot on a substrate.

2. Adhesive according to claim 1, in which the alkyl group of the alkyl (meth)acrylate has from 6 to 24 carbon atoms.

3. Adhesive according to claim 1, in which (A) is a copolymer of ethylene and of 2-ethylhexyl acrylate.

4. Adhesive according to any one of the preceding claims, in which the amount-of tackifying resin is from 50 to 180 parts (by weight), preferably 100 to 150, per 100 parts of (A).

5. Self-adhesive hot-melt pressure-sensitive adhesive (HMPSA) according to any one of the preceding claims comprising:
the copolymer (A)
at least one tackifying resin
at least one plasticizer
optionally stabilizers.

6. Hot-melt adhesive (HMA) according to any one of claims 1 to 4 comprising:
the copolymer (A)
at least one tackifying resin
at least one wax
optionally stabilizers.
